(19) United States
(12) Patent Application Publication
(10) Pub. No.: US 2010/0281485 A1
(43) Pub. Date: Nov. 4, 2010

(54) Method For Changing Over A System Having Multiple Execution Units

(76) Inventors: Markus Ferch, Grossbottwar (DE); Yorck von Collani, Beilstein (DE)

Correspondence Address: KENYON & KENYON LLP, ONE BROADWAY, NEW YORK, NY, 10004, US

(21) Appl. No.: 12/308,476

(22) PCT Filed: Sep. 19, 2007
(86) PCT No.: PCT/EP2007/059900

§ 371 Date: Jul. 12, 2010

(30) Foreign Application Priority Data
Oct. 10, 2006 (DE) 102006048173.9

(51) Int. Cl. G06F 9/48

(52) U.S. Cl. 718/103

(57) ABSTRACT

A system having multiple execution units and a method for its changeover are provided. The system having multiple execution units has at least two execution units, and may be changed over between a performance operating mode, in which the execution units execute different programs, and a comparison operating mode, in which the execution units execute the same program. The system has a scheduler, which is called by an execution unit to ascertain the next program to be executed. The remaining execution units are prompted to also call the scheduler if the program ascertained by the first called scheduler is to be executed in a comparison operating mode. A changeover unit changes over the system having multiple execution units from the performance operating mode into the comparison operating mode if the program to be executed ascertained by the last called scheduler is to be executed in the comparison operating mode, this ascertained program to be executed being executed as the program having the highest priority by all execution units after the changeover of the system into the comparison operating mode.

### FIELD OF THE INVENTION

The present invention relates to a system having multiple execution units and a method for its changeover, the system having multiple execution units having at least two execution units which may be changed over between a performance operating mode, in which the execution units execute different programs, and a comparison operating mode, in which the execution units execute the same program.

### BACKGROUND INFORMATION

In embedded systems, in particular in automobile technology or automation technology, there are applications or application programs in which an error in the hardware of the processor or the microcontroller hardware may have fatal consequences. To reduce this danger, monitoring measures are used to detect errors. In many applications or application programs, monitoring of this type is necessary almost continuously, while in other applications a monitoring function regularly, for example, periodically, or upon a specific request, for example, as a result of an interrupt, monitors whether the processor system or also other components are still functioning correctly.

German Patent Application No. DE 103 32 700 describes a method for changing over between at least two operating modes of a processor unit. The processor unit described therein has two execution units. A computer architecture of this type is also referred to as a dual-core computer architecture. The processor system described in German Patent Application No. DE 103 32 700 may be changed over between a performance operating mode and a comparison operating mode. In the performance operating mode, the execution units simultaneously execute different programs to increase the performance or the computing power. In contrast to performance operating mode PM, in comparison operating mode VM, the execution units execute identical programs and the result or the signals output by the execution units are compared to one another. If the comparison results in a deviation between the signals, this subsequently triggers an error signal. Comparison operating mode VM is used in particular in safety-critical programs to increase the safety. To increase the computing power, it is fundamentally advisable to have as many applications or programs as possible running in a mode having the highest possible performance, i.e., in performance operating mode PM. On the other hand, for safety-critical applications, almost all tasks or programs must be computed with high error recognition, i.e., in comparison operating mode VM.

An operating system BS performs the changeover between performance operating mode PM and comparison operating mode VM. Operating system BS decides on the basis of a program-specific identifier in which operating mode the program code is to be executed. This identifier may be assigned both statically and dynamically. There is also the possibility that a program is permanently assigned to a specific operating mode.

Multiple programs may be processed simultaneously on a system having multiple execution units. A so-called scheduler, which forms a part of operating system BS, decides which programs are actually executed. In a system having multiple execution units, the scheduler is executed separately on each execution unit. Therefore, multiple schedulers or operating system instances exist. The instances largely operate on the basis of the same data. A running program is also interrupted in certain circumstances by a so-called interrupt service routine ISR, as well as by the scheduler. Each interrupt service routine ISR is assigned to a specific event. If this event occurs, the instantaneously running program is interrupted and associated interrupt service routine ISR is executed. Each interrupt service routine ISR has an identifier which establishes the associated operating mode in which the interrupt service routine is to be executed.

In a system having multiple execution units which may be changed over between a performance operating mode PM and a comparison operating mode VM, it is necessary to identify and initiate the required operating mode change reliably. This procedure itself also costs computing time and computing power and may not be interrupted at any instant. If it is established by an operating system instance that a mode change into comparison operating mode VM is necessary, a changeover may not be performed immediately. Only in the case in which programs having a lower priority are executed on the further execution units or cores may the execution unit be withdrawn from the particular program for changeover into comparison operating mode VM. The ascertainment of the priority of programs on the remaining execution units is made more difficult in that in a system having multiple execution units, all active programs or interrupt service routines and the programs of the operating system itself are actually processed simultaneously. In contrast thereto, in a typical single-processor system, programs are processed in sequence by the single execution unit.

In a system having multiple execution units, there is a danger that an operating system instance, for example, an instance of the scheduler, will prompt or perform an operating mode change while the operating system instances running on the other execution units remain in the current operating mode. Because at least two execution units are required for an operating mode change in a system, in particular upon a change into comparison operating mode VM, the affected execution unit may therefore only be blocked for a specific time.

A simple example shall explain this. The totality of the programs includes four tasks T1, T2, T3, T4, for example, having the corresponding priorities, i.e., T1 has the highest priority “prio 3”, T2 has the second-highest priority “prio 2”, T3 has the third-highest priority “prio 1”, and last task T4 has the lowest priority “prio 0”, and tasks T1 through T4 are identified in such a way that tasks T1, T2 are to be executed in performance operating mode PM, while tasks T3, T4 are to be executed in comparison operating mode VM. For example, the system having multiple execution units has two execution units or CPUs. First execution unit CPU1 first executes highest-priority task T1 in performance operating mode PM and the other execution unit or CPU executes task T2 having the second-highest priority. Thus, as soon as task T1 is ended, operating system BS is called by first execution unit CPU1 and the scheduler decides which task T is to be executed next. In the given example, the scheduler decides on task T3, because it has the next highest priority “prio 1”. This task T3 has an attribute or an identification, however, which indicates that this task T3 is to be executed in comparison operating mode VM. The system having multiple execution units is thus to be changed over into a comparison operating mode VM. Task T2 still runs on second execution unit CPU2. The scheduler therefore waits until task T2 has ended on CPU2. As soon as task T2 has ended on CPU2, the scheduler or operating system BS switches both execution units into comparison operating mode VM and starts task T3. No conflict arises in this case. However, in a further example, if task T2 has a lower priority than task T3, for example, if task T2 has a “prio 1”, while task T3 has a “priority 2”, in a given scenario operating system BS must, after ending task T1, which has been executed on CPU1, immediately interrupt task T2 still running on CPU2 and have task T3 run on both execution units. However, operating system BS itself must be executed on an execution unit. In the given example, operating system BS is executed on first execution unit CPU1, which has become free, and may start task T3. For this purpose, the operating system must determine the priority of task T2 which is currently running on execution unit CPU2. The comparison of the priorities of tasks T2 and T3 on first execution unit CPU1 requires a certain amount of time, however. During the time span or duration required for the priority comparison, however, the case may arise that second execution unit CPU2 ends task T2 and in turn calls the operating system or the scheduler. In the given example, the second execution unit would call remaining task T4, which is to be executed in comparison operating mode VM, and a collision would occur between tasks T3 and T4, which both require first and second execution units CPU1, CPU2. The occurring collision may always occur if a called task T has to run in a comparison operating mode VM.

### SUMMARY

It is an object of the present invention to provide a system having multiple execution units and a method for its changeover, in which collisions are avoided when changing over into a comparison operating mode.

The present invention provides an example method for changing over a system having multiple execution units, which has at least two execution units, from a performance operating mode PM, in which the execution units execute different programs, into a comparison operating mode VM, in which the execution units execute the same program, having the following steps, namely

calling of a scheduler by an execution unit, the called scheduler ascertaining the next program to be executed,

prompting the remaining execution units to also call the scheduler if the next program to be executed is to be executed in comparison operating mode VM, and

changing over the system having multiple execution units from performance operating mode PM into comparison operating mode VM, if the program to be executed ascertained by the last called scheduler is to be performed in comparison operating mode VM, this program to be executed ascertained by the last called scheduler being executed as the program having the highest priority by all execution units in comparison operating mode VM of the system having multiple execution units.

In a preferred specific embodiment of the method according to the present invention, the execution unit which first calls the scheduler to ascertain the program to be executed next waits until all remaining execution units have also ascertained a program to be executed next by the call of the scheduler, and it is only then checked whether the program ascertained by the last called scheduler, which forms the program having the highest priority, is to be ascertained in a comparison operating mode VM.

In one specific embodiment of the method according to the present invention, the execution unit which first called the scheduler calls the scheduler again if the program ascertained by the last called scheduler is not to be performed in comparison operating mode VM.

In one specific embodiment of the method according to the present invention, the program to be executed is executed directly without changing over if the called scheduler ascertains a program, which is not to be executed in a comparison operating mode VM, but rather in a performance operating mode PM, as the next program to be executed.

In one specific embodiment of the method according to the present invention, an execution unit which calls the scheduler to ascertain the next program to be executed compares the priority of the ascertained program to the priorities of all programs currently being executed on the other execution units, if the ascertained program is to be executed in a comparison operating mode VM.

In one specific embodiment of the method according to the present invention, the execution unit which first called the scheduler passes into an idle operating mode (IDLE) and waits until the remaining execution units have each ended their programs if a program currently being performed on another execution unit has a higher priority than the program to be executed next ascertained by the first called scheduler.

In one specific embodiment of the method according to the present invention, the execution unit which calls the scheduler to ascertain the program to be executed next prompts the other execution units to also call the scheduler in that it transmits a request signal to the other execution units if the program to be executed next is to be executed in a comparison operating mode VM.

In one specific embodiment of the method according to the present invention, the request signal is formed by an interrupt signal.

In one specific embodiment of the method according to the present invention, the execution units are each formed by a processor, a coprocessor, a floating-point calculation unit, an arithmetic logic unit, or by a digital signal processor.

In one possible specific embodiment of the method according to the present invention, an execution unit calls the scheduler after ending an executed program.

The present invention also provides an example system having at least two execution units, which may be changed over between a performance operating mode PM, in which the execution units execute different programs, and a comparison operating mode VM, in which the execution units execute the same program, having

a scheduler which is called by an execution unit to ascertain the next program to be executed, the remaining execution units being prompted to also call the scheduler, if the program ascertained by the first called scheduler is to be executed in comparison operating mode VM, and having

a changeover unit, which changes the system having multiple execution units over from performance operating mode PM into comparison operating mode VM, if the program to be executed ascertained by the last called scheduler is to be executed in comparison operating mode VM, this ascertained program to be executed being executed as the program having the highest priority by all execution units after the changeover of the system having multiple execution units into comparison operating mode VM.

### BRIEF DESCRIPTION OF THE DRAWINGS

Preferred specific embodiments of the system according to the present invention having multiple execution units and of the method according to the present invention for its changeover are described below with reference to the figures to explain features of the present invention.

FIG. 1 shows a possible specific embodiment of the system according to the present invention having multiple execution units.

FIG. 2A shows a flow chart to explain the changeover method according to an example embodiment of the present invention.

FIG. 2B shows a further flow chart to explain the changeover method according to an example embodiment of the present invention.

### DETAILED DESCRIPTION OF EXAMPLE EMBODIMENTS

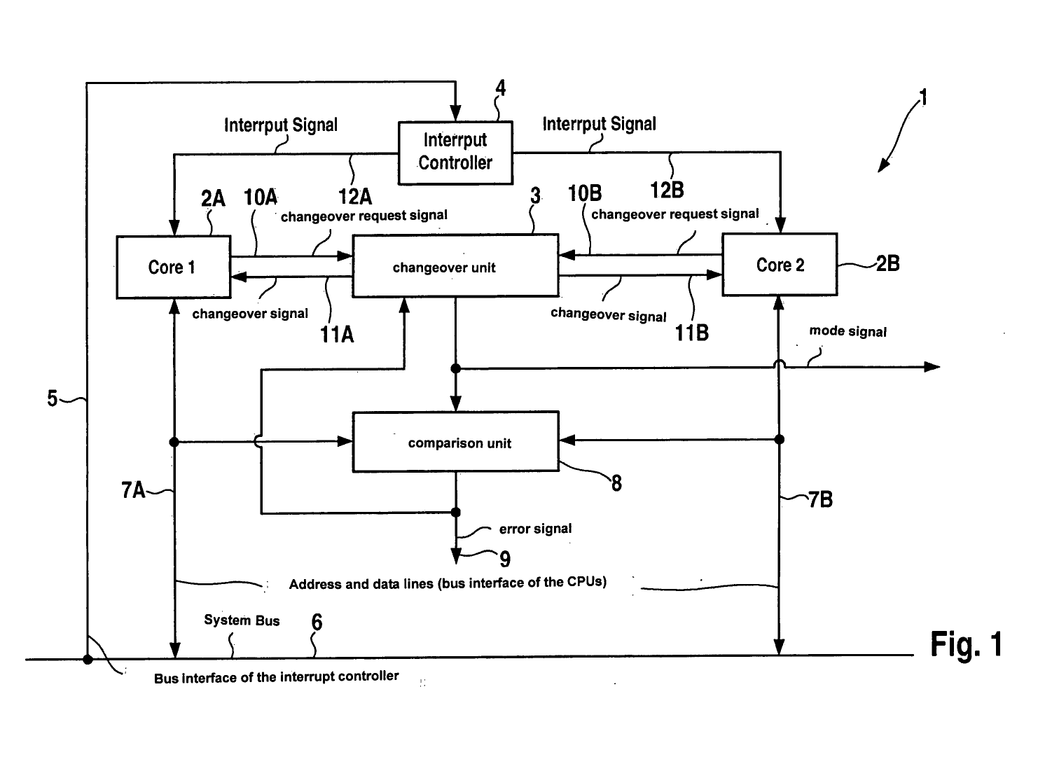

As may be seen from FIG. 1, system 1 shown in FIG. 1 is a dual-core system having two execution units 2A, 2B. Execution units 2A, 2B may be arbitrary calculation units, for example, a complete microprocessor, a coprocessor, a digital signal processor DSP, a floating-point calculation unit FPU, or an arithmetic logical unit ALU. Both execution units 2A, 2B of the system having multiple execution units 1 are connected to a changeover unit 3. In addition, the system having multiple execution units has an interrupt controller 4, which is connected via a bus interface 5 to a system bus 6. System bus 6 is in turn connected via address and data lines 7A, 7B to both execution units 2A, 2B. Address and data lines 7A, 7B form a bus interface for execution units 2A, 2B with system bus 6. System 1 contains, in addition to changeover unit 3, a comparison unit 8, which compares the signals output via data lines 7A, 7B from execution units 2A, 2B. System 1 having both execution units 2A, 2B shown in FIG. 1 may be changed over between a performance operating mode PM, in which execution units 2A, 2B execute different programs, and a comparison operating mode VM, in which execution units 2A, 2B execute the same program. In comparison operating mode VM, comparison unit 8 compares the logical output signals of execution units 2A, 2B. As soon as a signal deviation occurs, comparison unit 8 generates an error signal which it outputs via a control line 9. In addition to the application programs, execution units 2A, 2B also execute programs of operating system BS. A part of operating system BS is formed by the scheduler, which selects the next program to be executed, and assigns one of the two cores or execution units 2A, 2B for execution. The scheduler may, for example, after ending of the program by an execution unit, be called to ascertain the next program to be executed, the remaining execution units also being prompted in system 1 according to the present invention to call the scheduler if the program ascertained by the first called scheduler is to be executed in a comparison operating mode VM. Changeover unit 3 changes execution units 2A, 2B over from a performance operating mode PM into comparison operating mode VM if the program to be executed ascertained by the last called scheduler is to be executed in comparison operating mode VM. This ascertained program to be executed is executed as the program having the highest priority by all execution units 2A, 2B after the changeover of system 1 into comparison operating mode VM. If first execution unit 2A, after calling the scheduler, has a task to be executed next which is to be executed in a comparison operating mode VM, the operating system scheduler or the operating system scheduler instance which runs on execution unit 2A signals to all execution units that it wishes to start a task or a program in comparison operating mode VM. This prompts the remaining execution units to in turn call the operating system scheduler, which is a specific algorithm, while the execution unit which first called the scheduler waits.

In the simple example described above having four tasks T1, T2, T3, T4, T1 having the highest priority (prio 3), T2 having the second-highest priority (prio 2), T3 having the third-highest priority (prio 1), and T4 having the lowest priority (prio 0), T1, T2 being executed in performance operating mode PM and T3, T4 being executed in comparison operating mode VM, execution unit 2A calls the operating system scheduler after ending task T1, which prompts execution unit 2B to interrupt the program or task T2 currently running and to in turn call the operating system scheduler. As shown in FIG. 1, execution unit 2A transmits a changeover request signal to changeover unit 3 via a line 10A. In the same way, second execution unit 2B may signal a changeover request to changeover unit 3 via a line 10B. Changeover unit 3 applies a changeover signal to execution units 2A, 2B via control lines 11A, 11B if needed.

In the specific embodiment shown in FIG. 1 of the system having multiple execution units 1 according to the present invention, it contains one interrupt controller 4. In alternative embodiments, multiple interrupt controllers 4 may be provided. Interrupt controller 4 is programmed in such a way, for example, that it may trigger an interrupt controlled by software, i.e., an internal interrupt. Interrupt controller 4 outputs the interrupt requests via lines 12A, 12B to execution units 2A, 2B separately or simultaneously to both processors 2A, 2B. In one possible embodiment, the interrupts managed by interrupt controller 4 are prioritized. However, this is not absolutely necessary. In one possible embodiment, an interrupt having the lowest priority may be used to signal a mode change into comparison operating mode VM. An interrupt service routine ISR is assigned to every occurring hardware interrupt. Interrupt service routine ISR has an identifier which indicates whether or not interrupt service routine ISR must be executed in comparison operating mode VM. If an interrupt service routine ISR does not have to be executed in comparison operating mode VM and the execution units in which the interrupt service routine is to be executed are currently in a comparison operating mode VM, no mode change is performed.

In one possible specific embodiment, an interrupt service routine has precedence over the execution of an application program. If an interrupt service routine ISR is processed in a comparison operating mode VM, interrupt controller 4 is programmed in such a way that an interrupt request which interrupt controller 4 receives via line 5 from system bus 6 is transmitted to both execution units 2A, 2B via lines 12A, 12B. In an execution unit or a processor core which executes a program code of operating system BS, no interrupt queries or interrupt requests may be processed on this execution unit or processor. If a hardware interrupt occurs, the following steps are executed: firstly the current processor state including the operating mode is secured and/or saved. Subsequently, the operating mode in which associated interrupt service routine ISR is to be executed is ascertained and if needed a changeover is performed into comparison operating mode VM. All interrupts having higher priority are then released. Subsequently, interrupt service routine ISR is executed and the secured and/or saved processor state is produced again. If needed, a changeover into performance operating mode PM is subsequently performed again.

In system 1 having multiple execution units according to the present invention shown in FIG. 1, the scheduling of a task or a program is performed as follows: if system 1 having multiple execution units is in a comparison operating mode VM, all execution units 2A, 2B simultaneously execute the same program or task T. If scheduler SCH is called for a task change for any reason, for example, if an execution unit indicates that its program has ended, scheduler SCH, which forms a part of operating system BS, ascertains that program or that task T having the highest priority and changes over system 1 either into performance operating mode PM or comparison operating mode VM on the basis of the program identification.

If system 1 is in performance operating mode PM, multiple scheduler instances exist, i.e., scheduler instance SCH-A exists on first execution unit 2A and scheduler instance SCH-B is on second execution unit 2B.

For example, if scheduler instance SCH-B ascertains next task Tₓ having the highest priority and ascertained program or task Tₓ requires execution in comparison operating mode VM, the scheduling data structures are initially not changed. Instead, the priority of the program or task T_{y} on processor 2B is ascertained by scheduling instance SCH-A. If this task T_{y} has a lower priority than next task Tₓ, execution unit 2B is signaled via interrupt that a changeover request exists. If this task T_{y} has a higher priority than task Tₓ, scheduler SCH-A activates a so-called IDLE task, which produces an idle operating state. After the signaling, scheduling instance SCH-A waits for scheduling instance SCH-B to be finished (barrier). If an interrupt service routine ISR is executed on execution unit 2A, the processing of the changeover request query is first begun when all interrupts have been processed on processor 2A. If execution unit 2A activates operating system BS because of the changeover request of scheduler instance SCH-A, scheduler instance SCH-B is also called by execution unit 2A. If scheduler instance SCH-B which runs on execution unit 2B also comes to the result that task Tₓ, must be executed, scheduling instance SCH-B releases scheduling instance SCH-A, which runs on execution unit 2A, from the block or barrier.

If scheduling instance SCH-B comes to the result that not task Tₓ, but rather a task T_{z}, must be executed in performance operating mode PM, i.e., the priority of task T_{z}, is greater than the priority of task Tₓ, scheduling instance SCH-A is also released from the barrier. Scheduling instance SCH-B then prompts the execution of task T_{z}, and scheduling instance SCH-A once again ascertains a task or a program having the highest priority (reschedule).

If scheduling instance SCH-B comes to the result that not task Tₓ, but rather a task T_{z} must be executed in comparison operating mode VM, i.e., the priority of task T_{z} is greater than the priority of task Tₓ, scheduling instance SCH is also released from the barrier. Scheduling instances SCH-A, SCH-B then prompt the execution of task T_{z} on both execution units.

In one possible embodiment, an internal operating flag may be set by scheduling instance SCH-A. This flag then signals the changeover request. If execution unit 2B is simultaneously processing a program of operating system BS, scheduling instance SCH-A must wait until second execution unit 2B leaves operating system BS and receives the changeover request by the interrupt. Second execution unit 2B may query the flag at a suitable point and if needed call scheduler SCH-B or perform a reschedule without having to leave operating system BS.

In the method according to the present invention for a changeover into comparison operating mode VM, the scheduler is thus called not only by one execution unit, but also by the other execution units. The changeover procedure only occurs when the program to be executed ascertained by last called scheduler SCH is to be performed in comparison operating mode VM. This program to be executed ascertained by the last called scheduler is then executed as the program having the highest priority by all execution units 2 in comparison operating mode VM of system 1. Execution unit 2 which first called scheduler SCH to ascertain the program to be executed next waits until all remaining execution units 2 have also ascertained a program to be executed next by the call to the scheduler. It is only then checked whether the program ascertained by last called scheduler SCH, which is the program having the highest priority, is to be executed in comparison operating mode VM.

If the case occurs that the program ascertained by last called scheduler SCH is not to be performed in comparison operating mode VM, execution unit 2 which first called scheduler SCH calls the scheduler again. This case may occur if an event which requires another prioritization of tasks T has occurred in the period of time between the call to scheduler SCH by first execution unit 2 and the call to scheduler SCH by last execution unit 2.

For the case in which called scheduler SCH ascertains a program as the next program to be executed which is not to be executed in a comparison operating mode VM, but rather in a performance operating mode PM, the program or task T to be executed is executed directly without changeover.

In one specific embodiment of the method according to the present invention, execution unit 2 which first called scheduler SCH passes into an idle operating mode (IDLE) until remaining execution units 2 have ended their programs if a program just performed by another execution unit 2 has a higher priority than the program to be executed next ascertained by the first called scheduler.

In one specific embodiment of the method according to the present invention, execution unit 2 which first called the scheduler to ascertain the program to be executed next prompts other execution units 2 to also call the scheduler in that it transmits a request signal to the other execution units if the next program to be executed is to be executed in a comparison operating mode VM. This request signal is preferably formed by an interrupt signal.

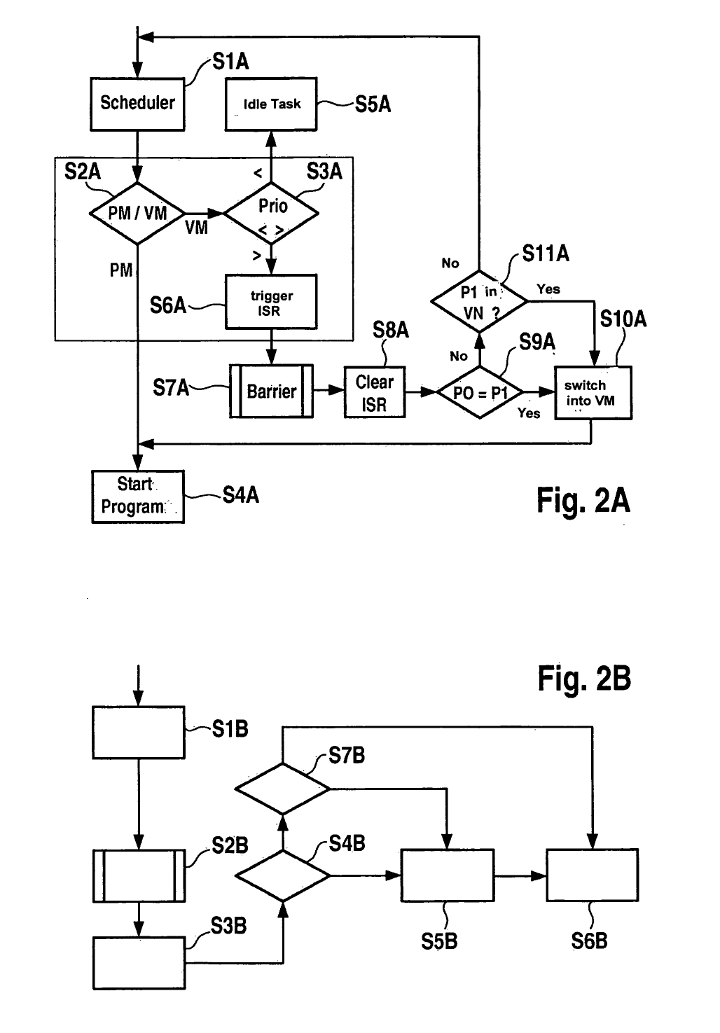

FIG. 2A shows a flow chart to explain the example method according to the present invention. The flow chart shown in FIG. 2A shows the sequence within first execution unit 2A, for example. If a program or a task, such as task T1, is terminated by execution unit 2A, for example, the scheduler is called. After scheduler SCH is called in step S1A, it is ascertained in step S2A whether the next program or next task T is to be executed in comparison operating mode VM or in performance operating mode PM. If task T2 runs on second execution unit 2B in the given example and task T3 having priority 1, which has to run in comparison operating mode VM, is selected by scheduler SCH in accordance with the priority as the next task to be executed, the sequence branches to step S3A. Vice versa, if the next program to be executed is to be executed in performance operating mode PM, the program may be started directly in step S4A. In step S3A, the priority of next task T3 to be executed is compared to the priority of the program which is currently running on other execution unit 2B. In the given example, this is task T2 having priority prio 2. If the program which runs on the other execution unit, i.e., on execution unit 2B, has a higher priority, it may not be interrupted. In this case, execution unit 2A passes into an idle operating mode (IDLE) in step S5A. In the given example, the priority of running task T2 (prio 2) is higher than the priority of task T3 (prio 1), so that step S5A is executed. Vice versa, if the priority of the program on other execution unit 2B is lower than the priority of the next task, in step S6A a changeover request is signaled by interrupt from execution unit 2A to execution unit 2B. An interrupt service routine ISR is triggered. After the signaling, first execution unit 2A enters a so-called barrier in step S7A, in which execution unit 2A waits for a signal of execution unit 2B. The barrier is a software synchronization data construct in which an execution unit or a CPU waits until the other execution unit has reached the same program processing point. After triggering interrupt service routine ISR, second execution unit 2B in turn calls operating system scheduler SCH, the sequence shown in FIG. 2B being performed. If execution unit 2B has also reached the barrier, it is checked by both execution units 2A, 2B more or less in parallel, but not in comparison operating mode VM, whether both execution units 2A, 2B have come to the same result, i.e., whether both execution units 2A, 2B wish to execute the same program or task next. The reaching of the barrier by execution unit 2A is shown as step S7A in FIG. 2. If necessary, interrupt service routine ISR is subsequently triggered in S8A. The check as to whether both execution units 2A, 2B have come to the same result, i.e., want to execute the same program or task T, is shown in step S9A. If the same program or task T is ascertained by both execution units 2A, 2B after the particular call of scheduler SCH, system 1 is switched into comparison operating mode VM in step S10A and the program or task is subsequently executed or started in step S4A in both execution units 2A, 2B. For example, if result comparison S9A has the result that second execution unit 2B also wants to execute task T3 to be executed in comparison operating mode VM after calling the scheduler, this task T3 is started in step S4A after changeover into comparison operating mode VM in step S1OA. Vice versa, if it is established that other execution unit 2B delivers another result, it is checked in step S11A if program or task T selected by execution unit 2B is also to be executed in comparison operating mode VM. If so, in step S1OA, system 1 is switched into comparison operating mode VM and the task which is ascertained by last called scheduler SCH, i.e., the task ascertained by execution unit 2B, is started in step S4A. If it is established in step S11A that task T ascertained by execution unit 2B is not to be executed in comparison operating mode VM, but rather in performance operating mode PM, execution unit 2A calls scheduler SCH again in step S1A.

FIG. 2B shows the complementary sequence in other execution unit 2B. After triggering of interrupt service routine ISR in step S6A according to FIG. 2A by execution unit 2A, execution unit 2B in turn calls scheduler SCH in step S1B shown in FIG. 2B. Execution unit 2B enters corresponding interrupt service routine ISR. Execution unit 2B first starts scheduler SCH in step S1B and subsequently enters the barrier in step S2B so that processor 2A also operates further. If necessary, the interrupt is canceled in interrupt controller 4 in step S3B. In step S4B, as shown in FIG. 2B, it is ascertained whether both execution unit 2A and also execution unit 2B have ascertained the same task T or the same program. If execution units 2A, 2B have ascertained the same task T, the changeover into comparison operating mode VM occurs in step S5B and task T is subsequently executed in step S6B. If second execution unit 2B has ascertained a different task than execution unit 2A for the execution, the procedure branches to step S7B. If the task to be executed by second execution unit 2B is also to be executed in comparison operating mode VM, a changeover into comparison operating mode VM is again performed in step S5B, and the last ascertained task, i.e., the task ascertained by execution unit 2B, is executed in step S6B. If it is established in step S7B that task T ascertained by second execution unit 2B is not to be executed in comparison operating mode VM, but rather in performance operating mode PM, for example, no changeover occurs into comparison operating mode VM and this task is executed in step S6B.

The program sequences shown in FIGS. 2A, 2B are complementary. For example, if second execution unit 2A enters operating system BS independently of the signaling of a changeover request by execution unit 2A, in this case second execution unit 2B performs the sequence shown in FIG. 2A and execution unit 2A performs the sequence shown in FIG. 2B.

The example method according to the present invention prevents blocking of execution units 2 upon changeover into a comparison operating mode VM in every case. The example method according to the present invention is particularly suitable for systems having two or more execution units. For example, if system 1 has two execution units 2, in the method according to the present invention, the scheduling is performed twice, because the task ascertained by the last called scheduling instance has the current highest priority and is accordingly to be executed. The two scheduling instances are synchronized to one another because of the barrier contained in the sequence.

1-11. (canceled)

12. A method for changing over a system having at least two execution units, from a performance operating mode in which the execution units execute different programs, into a comparison operating mode, in which the execution units execute the same program, the method comprising:
calling a scheduler by an execution unit, the called scheduler ascertaining a next program to be executed;
prompting remaining execution units to also call the scheduler when the next program to be executed is to be executed in the comparison operating mode; and
changing over the system from the performance operating mode into the comparison operating mode if the next program to be executed is to be executed in the comparison operating mode, the next program to be executed being executed as a program having the highest priority by all execution units in the comparison operating mode of the system.

13. The method as recited in claim 12, wherein the execution unit which first calls the scheduler to ascertain the next program to be executed waits until all remaining execution units have also ascertained a program to be executed next by calling the scheduler and it is only then checked whether the program ascertained by the last called scheduler, which forms the program having the highest priority, is to be executed in the comparison operating mode.

14. The method as recited in claim 13, wherein, if the next program ascertained by the last called scheduler is not to be executed in the comparison operating mode, the execution unit which first called the scheduler calls the scheduler again.

15. The method as recited in claim 14, wherein if the called scheduler ascertains a program to be executed next which is not to be executed in a comparison operating mode but rather in a performance operating mode, the program to be executed is executed directly without changeover.

16. The method as recited in claim 12, wherein an execution unit which calls the scheduler to ascertain the next program to be executed compares a priority of the ascertained program to priorities of all programs currently executed on the other execution units, if the ascertained program is to be executed in a comparison operating mode.

17. The method as recited in claim 16, wherein, if a program currently being executed on another execution unit has a higher priority than the program ascertained as the next program to be executed by the first called scheduler, the execution unit which first called the scheduler passes into an idle operating mode and waits until the remaining execution units have each ended their programs.

18. The method as recited in claim 17, wherein the execution unit which first calls the scheduler to ascertain the next program to be executed prompts the other execution units to also call the scheduler in that it transmits a request signal to the other execution units if the next program to be executed is to be executed in a comparison operating mode.

19. The method as recited in claim 18, wherein the request signal is formed by an interrupt signal.

20. The method as recited in claim 12, wherein the execution units are each formed by one of a processor, a coprocessor, a floating-point calculation unit, an arithmetic logic unit, or by a digital signal processor.

21. The method as recited in claim 12, wherein an execution unit calls the scheduler after ending an executed program.

22. A system, comprising:
at least two execution units which may be changed over between a performance operating mode, in which the execution units execute different programs, and a comparison operating mode, in which the execution units execute the same program;
a scheduler which is called by an execution unit to ascertain a next program to be executed; wherein remaining execution units are prompted to also call the scheduler if the program ascertained by the first called scheduler is to be executed in the comparison operating mode; and
a changeover unit which changes the system over from the performance operating mode into the comparison operating mode if the program to be executed ascertained by the last called scheduler is to be executed in the comparison operating mode, the ascertained program to be executed being executed as a program having the highest priority by all execution units after the changeover of the system into the comparison operating mode.
